(19) United States
(12) Patent Application Publication
(10) Pub. No.: US 2025/0269377 A1
(43) Pub. Date: Aug. 28, 2025

(54) Adaptation of a Processing of an in Particular Biological Sample Using a Processing Unit

(71) Applicant: Robert Bosch GmbH, Stuttgart (DE)

(72) Inventors: Martin Schulz, Winterbach (DE); Jochen Rupp, Stuttgart (DE)

(21) Appl. No.: 18/257,509

(22) PCT Filed: Dec. 10, 2021
(86) PCT No.: PCT/EP2021/085150

§ 371 Date: Oct. 31, 2023

(30) Foreign Application Priority Data
Dec. 16, 2020 (DE) 10 2020 215 986.6

(51) Int. Cl. B01L 3/00; G01N 35/00

(52) U.S. Cl. CPC B01L 3/545; B01L 3/502715; G01N 35/00732; B01L 2200/14; B01L 2300/021; B01L 2300/0816; G01N 2035/00831; G01N 2035/00851

(57) ABSTRACT

A method for adapting a processing of an in particular biological sample using a processing unit includes identifying a cartridge in an identification region for a processing parameter, reading the processing parameter from the identified cartridge by the processing unit and adapting the processing depending on the processing parameter, and processing the sample in the cartridge with the processing unit.

### PRIOR ART

So-called lab-on-a-chip systems (abbreviated as LoC systems) are microfluidic systems that accommodate functionalities of a macroscopic laboratory on a plastic substrate for a process that is as fully automated as possible.

These systems often comprise both a cartridge into which a sample to be analyzed is inserted and an analyzer into which the cartridge is placed to perform the analysis. Whereas the analyzer typically comprises all the active technical means, e.g., heaters, hydraulic or pneumatic controls for the cartridge, the cartridge, which is usually disposable, is inexpensively designed without active components, but equipped with the required biochemical reagents.

For example, DE 10 2016 222 075 A1 and DE 10 2016 222 072 A1 each describe a microfluidic system comprising a cartridge for receiving a biological sample and a processing unit for processing the sample in the cartridge. The processing unit can be configured to perform different processing methods depending on the type of analysis desired. For this purpose, the processing unit usually comprises one or more interfaces for the required data input, e.g., a touch-sensitive display, a camera and/or a wireless communication interface such as Bluetooth, WLAN or NFC.

### DISCLOSURE OF THE INVENTION

### Advantages of the invention

Against this background, the invention relates to a method for adapting a processing of a sample using a processing unit. For this purpose, a cartridge is labeled in an identification region for a processing parameter and the processing unit reads in the processing parameter. If the reading is successful, the intended processing of the sample in the cartridge is adjusted depending on the processing parameter. Subsequently, processing can be performed by the processing unit.

In particular, the sample can comprise a biological sample, e.g., a body fluid such as blood, urine, sputum, or a smear or tissue from an animal or human.

The processing unit can in particular be understood as a microfluidic processing unit or analysis unit for processing and/or analysis of the sample received in the cartridge which is, e.g., based on a processing unit described in DE 10 2016 222 075 A1 or DE 10 2016 222 072 A1. The processing unit and cartridge can together form a microfluidic system, in particular a lab-on-a-chip system. In this case, the processing unit is configured to adapt the processing as a function of the recorded processing parameter. The object of the invention is therefore also such a processing unit. The processing unit preferably comprises a communication interface for reading, in particular an optical interface, e.g., camera or a reader for reading bar codes or two-dimensional codes.

A cartridge can in particular be understood to mean a microfluidic cartridge based on, e.g., a cartridge described in DE 10 2016 222 075 A1 or DE 10 2016 222 072 A1. Such cartridges are often designed as passive components and are operated by the processing unit in order to process the sample received in the cartridge. The cartridge includes the identification region for the processing parameter and is therefore also an object of the invention. A further object of the invention is to provide a microfluidic system comprising such a cartridge and the processing unit described hereinabove.

Processing by the processing unit can be understood to mean processing of the cartridge and the sample in the cartridge, in particular microfluidic processing, e.g., a biochemical method for detecting substances or pathogens.

A processing parameter can be understood in particular as information which, after processing by the processing unit, influences the processing of the cartridge. Such processing typically comprises control of a fluidic flow in the cartridge for processing the sample, for example, control of valves and actuators for transporting the sample and/or mixing the sample with other substances present in the cartridge, and/or control of temperature controls for setting a local temperature in the cartridge, e.g., in order to perform a polymerase chain reaction. The information encoded by the processing parameter can thereby preferably effect an adaptation of individual or several processing steps of the processing, in particular a determination or modification of a part of the fluidic flow.

An identification region for a processing parameter can be understood in particular as a predefined region of the cartridge in which the identification takes place when the cartridge is used as intended. The identification region can be a marked region on a surface of the cartridge, e.g., a bordered region or a region marked over a surface. Preferably, the identification region already contains initial information about the processing parameter. In this case, the identification can preferably be done by adding to the first piece of information, e.g. by marking it (e.g., highlighting it or checking it) or by adding another piece of information, e.g., adding it by hand or printing or pasting it with the other information. The first piece of information can therefore also be referred to as “identifiable information”.

In a preferred embodiment, the processing unit can perform a plurality of different processing operations, e.g., independent or parallel analyses of samples for different pathogens (different viruses, and/or bacteria, and/or other pathogens). In other words, the processing unit is preferably configured to perform several different processing methods. At least one of the processing sequences or one of the processing methods can be adapted and thus modified by the processing parameter. Preferably, therefore, an adaptation of processing can be understood not as a mere selection of one of several processing methods, but as an adaptation of one or more steps of one or more specific processing methods.

The method presented therefore enables flexible processing of the cartridge and thus, in particular, increased universality of known microfluidic, (partially) automated processing methods, whereby the respective parameterization of the processing can advantageously be automated via the reading of the processing parameter. The method presented furthermore provides the processing parameter directly by the labeled cartridge, which advantageously increases the security for a correct processing, especially for a correct assignment of cartridge and processing.

The processing parameter can include information regarding the desired analysis of the sample, for example, a determination of the entities to be detected, such as pathogens to be detected, or a determination of termination criteria of the processing, and thus preferably a determination of the desired quality of the processing. In advantageous embodiments of the invention, the cartridge can also be labeled with multiple processing parameters. By reading the one or plurality of processing parameters, the processing can advantageously be adjusted automatically. Doing so reduces the effort and error-proneness due to an otherwise manual input by the user.

Particularly preferably, the processing parameter includes information about the sample type. Fluidic samples, in particular body fluids or tissues, are often mixed with a medium, in particular a medium for stabilization and/or preservation and/or preparation of the sample, also referred to as a sample medium. In this context, preparation of the sample can be understood as a reaction, in particular a chemical or biochemical reaction, and thus a change in the sample. For example, the medium can be, among other things, a preservation or transport medium such as eNAT™ or UMT™, or the absorbent cotton of a cotton swab. The processing parameter can therefore include information about the medium, so the processing of the sample is preferably adjusted depending on the sample medium. In particular, as stated hereinabove, one or a plurality of steps of a specific processing method can be adapted depending on the type of sample, e.g., a way of purifying the sample. In the context of the invention, the term “sample type” can be equated with the totality of the sample and sample medium, since the medium typically plays a significant role in determining the sample type of the sample.

The coding of the information on the sample type by the processing parameter thus has the advantage that, by adapting the processing to the type of sample and, in particular, to the type of medium, more reliable, efficient and effective sample processing can be performed with a higher probability of success and/or higher yield. In particular, this enables processing tailored to the sample type. Furthermore, it is advantageous that the processing unit can thus be used for a plurality of different sample types. In addition, as already stated above in general, the presented method provides the information about the sample type directly through the labeled cartridge, which advantageously increases the security for correct processing, correct sample input into the cartridge and correct assignment of sample type and processing.

According to a further preferable embodiment of the method, a request to the user to enter the processing parameter is made via a communication interface of the processing unit if the reading of the processing parameter is not successful. This request and also the input can, e.g., be performed via a touch-sensitive display of the processing unit. In particular, a reading process is unsuccessful if the information read cannot be processed, e.g., because the information of the processing unit is unknown or defective. A processing unit configured in this way has the advantage that processing cannot be aborted, but can be continued via interaction with the user.

Preferably, the cartridge identification can include a label (also referred to as a “label”), the label having an identification region for the processing parameter, in particular an identification region as described above. It is therefore also an object of the invention to provide such a label and a cartridge having such a label.

Advantageously, the proposed label enables a clear and physically permanent assignment of the cartridge and the processing parameter, in particular the sample type of the sample to be included or already included in the cartridge. Such a label can be applied to a surface of the cartridge without difficulty, enabling uncomplicated reading of the processing parameter labeled thereupon by the user and/or by the processing unit. For this purpose, the label can have an at least partially adhesive underside.

In one preferred embodiment, the label, in particular the identification region, includes identifiable information about a processing parameter. By the identifiable information is meant, as described above, a first information about the processing parameter, which is supplemented with a further information by a user and thus labeled. As described above, the addition of the further information can, e.g., be performed by ticking or marking the first information or by adding further information expressed in plain text or in code. The first information has the advantage that the user is already pointed to the relevant processing parameter and can easily select or determine or also specify the processing parameter by means of the identification or addition.

According to a particularly preferred embodiment, the label includes a first identification region for a first sample type and a second identification region for a second sample type. These two different regions have the advantage that it is easy to distinguish between the two sample types. The different regions can in particular be two regions on the upper side of the label, which locally overlap only partially or preferably not at all. The label can also have further identification regions for additional, in particular other, sample types, for example a third region or a third and fourth region, with the regions overlapping only partially or preferably not at all in terms of location.

In a particularly advantageous embodiment, at least one identification regions includes multiple identification fields. Preferably, at least one identification region has a first identification field and a second identification field. In this case, the first identification field can be provided for a specific sample type identifier. Preferably, the first identification field includes the sample type in plain text, such as the word “eNAT” or “UTM” or “Swab”, and preferably corresponds to the identifiable information described above. The second identification field can be provided for a selection of the sample type indicated in the first identification field. In this case, the selection can preferably be made by entering information (in particular the “further information” described above) in the second identification field, for example by labeling, in particular by manually checking or manually filling in the second identification field by the user. Alternatively, the entry can also be made by affixing another label in the second identification field. In this embodiment, the identification of the second identification field therefore advantageously indicates which sample type is present.

Preferably, the identification fields are different regions on the label, which locally overlap only partially or preferably not at all. Doing so has the advantage of a low risk that identification of one identification field, in particular manual identification in the form of filling in, ticking off, or affixing another label, will impair or damage another identification field.

At least one identification region can further include a third identification field. The third identification field can be provided for entering a sample identifier, the sample identifier preferably uniquely identifying a sample, as also described hereinabove. Alternatively, the label can include a sample identification region for a sample identifier independent of the identification region and the third identification field. A sample identifier means in particular a unique assignment or identification of the sample, in particular in relation to the sample collection and/or the person from whom the sample was taken. Advantageously, doing so facilitates tracking of the sample in the cartridge. For example, the sample identifier can be in the form of a code, particularly in the form of a numeric code, a bar code, or a two-dimensional code such as a QR code. The sample identifier can, e.g., be applied to a sample label, and the sample label can be applied to the third identification field. By entering the sample identifier, on the one hand the selection of the sample type is advantageously recorded and, on the other hand, the information about the sample is physically permanently associated with the cartridge and the sample type. The second identification field and the third identification field can also be designed as a common second identification field, so that the common second identification field can be filled in either manually or with another label, in particular the aforementioned sample label, as explained hereinabove.

At least one identification region can include a code, in which case the code encodes information, in particular a processing parameter such as an identifier for the sample type or an identifier for the sample. For example, the code is a bar code, a DataMatrix code, or a QR code. Preferably, the first identification region includes such a code for encoding the sample type, preferably in addition to a plain text for the sample type. Doing so has the advantage that both a human user and the processing unit can immediately detect the sample type present. If in particular, as explained hereinabove, one or more identification regions include one or multiple identification fields, then one or more of the identification fields can include such a code.

In one preferred embodiment of the invention, the cartridge includes a cartridge identifier. The cartridge identifier can in this case preferably include a unique designation of the cartridge or a unique designation of a type of cartridge, in particular in the form of a code. Preferably, the cartridge identifier can be applied to a surface of the cartridge.

According to an advantageous embodiment, the label includes a cartridge identification region for cartridge identification of the cartridge. Doing so has the advantage that both the processing parameter, in particular the sample type, and the identification of the cartridge are physically permanently linked via the label. Furthermore, applying the label to the cartridge ensures a permanent bond with the cartridge.

### BRIEF DESCRIPTION OF THE DRAWINGS

Exemplary embodiments of the invention are shown schematically in the drawings and explained in more detail in the following description. The same reference signs are used for the elements having the same effect and shown in the various drawings, so repeated description of these elements is omitted.

Shown are:

FIGS. 1a, 1b, exemplary embodiments of the label according to the invention,

FIG. 2 exemplary embodiments of the system according to the invention, comprising exemplary embodiments of the cartridge according to the invention and the processing unit according to the invention, and

FIG. 3 a flow diagram of an exemplary embodiment of the method according to the invention.

### EMBODIMENTS OF THE INVENTION

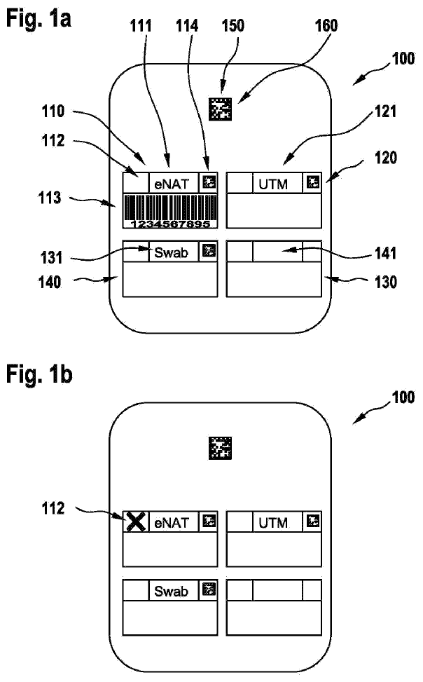

FIGS. 1a and 1b show an exemplary embodiment of the label 100 according to the invention. For example, as shown, the label 100 has a generally rectangular shape with optionally rounded corners and a size of, e.g., six centimeters by centimeters. The label 100 is designed to be applied to a surface of a microfluidic cartridge, e.g., via an adhesive bottom surface of the label 100. In this example, the processing parameter is the sample type.

In this example, the label 100 has a first identification region 110, which is bounded by a rectangular border. The first identification region includes four identification fields 111, 112, 113, 114, which are distinguished from one another by further lines. The first identification field 111 includes a preprinted name of a sample type in plain writing (“eNAT”). The second identification field 112 is provided for manual marking by the user, as shown in FIG. 1b. As an alternative to checking the box, a sample identifier can be entered into the third identification field 113, e.g., in the form of a bar code (as shown), e.g., by affixing another label to the third identification field 113. To this end, the third identification field has, e.g., a size of 25 millimeters by 10 millimeters, which corresponds to a typical size of labels for samples in the laboratory field. In this example, the fourth identification region 114 includes a QR code that encodes the sample type (in this case, “eNAT”) for optical reading by a processing unit. Due to the local separation of the identification fields 111, 112, 113, 114, the visibility of the first identification field 111 and also of the fourth identification field 114 and the respective sample type indicated therein is not impaired when the second identification field 112 is checked or when the third identification field is filled in. In this example, the entry in the first identification field 111 (“eNAT”) and/or the QR code in the fourth identification field 114 represent the identifiable information described above, which is labeled by checking the box in the second identification field 112 and/or entering it in the third identification field 113, thereby selecting the process parameter (in this case the sample type) eNAT.

In the illustrated exemplary embodiment, the label 100 includes four locally separated identification regions 110, 120, 130, 140, preferably all four regions 110, 120, 130, 140 each having the described four identification fields. Each identification region 110, 120, 130, 140 represents a different sample type, as shown in the respective first identification fields 111, 121, 131, 141, although in this example the first identification field 141 of the fourth identification region 140 is left blank for a user to fill in. By checking one of the second identification fields, as shown in the second identification field 112 in FIG. 1b, or by filling in one of the third identification fields, in particular by affixing a sample identification label 113 as shown in FIG. 1a, the type of sample is thus labeled as a processing parameter. In other embodiments, the label 100 can include a different number of identification regions and also a different number of identification fields in each case, whereby the number of identification regions can depend in particular on the number of possible different types of samples.

Further, the label 100 has, as a possible further processing parameter, a cartridge identifier 150 in a cartridge identification region 160 adjacent to the identification regions 110, 120, 130, 140, whereby the cartridge identifier 150 in this example is implemented as a QR code. The label 100 therefore provides a physical link between the cartridge identifier, the sample type identifier, and optionally the sample identifier.

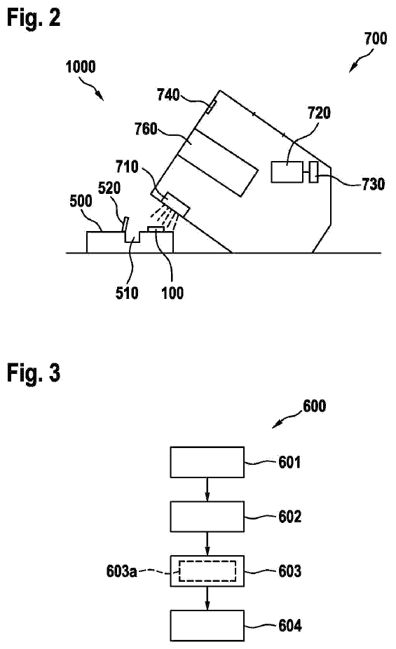

FIG. 2 shows an exemplary embodiment of a microfluidic system 1000 comprising exemplary embodiments of a processing unit 700 according to the invention and a cartridge 500 according to the invention.

The cartridge 500 comprises a sample chamber 510 for receiving the biological sample being processed using the cartridge 500 and the processing unit 700. The sample chamber 510 can in this case be closed using a lid 520 of the sample chamber 510 before the cartridge 500 is inserted into a well 760 of the processing unit 700 for processing.

In this example, the label 100 has already been applied to the cartridge 500 and can be read by the processing unit 700. To this end, the processing unit 700 comprises an optical sensor 710, e.g. a camera or barcode scanner. The processing unit 700 further comprises a wireless communication interface 730 for exchanging data, e.g., based on Bluetooth®, WLAN or NFC, and an interaction surface 740, e.g. a touch-sensitive display surface, also referred to as a “touch screen”, for entering and displaying information. The processing unit 700 further comprises means (not shown) for processing the cartridge 500. These means can be mechanical, pneumatic or thermal actuators typical in the microfluidics field for performing microfluidic processes in the cartridge, e.g., plungers, heating elements or compressed air ports.

A processor 720 of the processing unit 700 is configured to read one or multiple processing parameters, e.g., the sample type identifier, cartridge identifier, and optionally the sample identifier via the optical sensor 710, and to adjust and perform processing of the cartridge 500 depending on the sample type.

In this regard, FIG. 3 shows a flowchart of an exemplary embodiment of the method 600 according to the invention, which can, e.g., be performed using a microfluidic system 1000, as described hereinabove.

In a first step 601, a sample is taken, e.g. a biological sample from a human or an animal, e.g., a body fluid such as blood, sputum, or a swab. The sample is brought into contact with a medium used for preservation, and/or transport, or already during sampling, e.g., with a liquid medium such as eNAT™ or UTM™ or with a cotton swab. Before or after this, in a second step, a sample identifier is created to uniquely identify the sample, in particular in the form of a unique code, e.g. a number and/or a bar code.

In a second step 602, a cartridge 500 suitable for the sample and the desired type of processing is provided and labeled with one or more processing parameters in one or more identification regions. In this example, by checking one of the second identification fields or by filling in one of the third identification fields, in particular by affixing a sample identification label 113 (as shown in FIG. 1a) or by checking the second identification field 112 (as shown in FIG. 1b), it is thus determined as a processing parameter which sample type and thus which sample medium is present.

In a third step 603, the processing parameter is read via the optical sensor 710 of the processing unit 700 and an adjustment of the processing is made (in this case, a determination of the microfluidic sequences suitable for the sample medium present and thus the sample type present). The reading of the processing parameter in this case preferably comprises the optical reading of a large portion or preferably the entire label 100. Quite preferably, at least all identification regions 110, 120, 130, 140 present on the label 100 are read. For this purpose, the processing unit 700 can be configured to recognize the identification regions 110, 120, 130, 140, e.g., via the illustrated boundary lines on the label and/or the QR codes in the fourth identification fields. Identification of one of the identification regions 110, 120, 130, 140 made in the second or third identification fields is then used by the processor 720 of the processing unit in order to determine the specified sample type. In this case, the labeled identification region 110, in particular the labeled second or third identification field, determines which sample type is present, this sample type being designated by the plain text entry in the first identification region 111 and/or the coded entry in the fourth identification region 114. In the exemplary embodiment according to FIG. 1a, the sample type “eNAT” was labeled by entering an identification in the form of a barcode and numerical code in the third identification field 113. In the exemplary embodiment according to FIG. 1b, the sample type “eNAT” was also labeled, but in this case by checking the second identification field 112. In both cases, as shown in FIGS. 1a and 1b, the sequence of the upcoming processing is then adapted for a processing of a sample with the sample medium “eNAT” by the processor 720. For example, the method of purification of the sample is adapted for the most effective and efficient extraction of the essential sample components from the eNAT medium. This is, e.g., performed by adapting ultrasonic lysis parameters in duration and intensity, the volume adaptation of lysis, binding or wash buffers, and process parameters such as incubation times, temperatures, and sequential or parallel fluidic processes.

In another exemplary embodiment, a dry sample such as a swab can be labeled “swab”. The flow of the associated processing is thus adapted for a processing of a sample with the “swab” sample medium by the processor 720. An increased volume is used in this case to flush out the dry swab during processing.

The adaptation of processing can also comprise adaptation of processing steps, e.g., in particular a selection of evaluation paths of measured test results and cartridge data, and a display mode of results. For example, defining a curve scaling for a sample type can be advantageous.

If the information read about the processing parameter cannot be processed by the processing unit 700, then a request to the user to manually enter the processing parameter can be made in an intermediate step 603a via a communication interface, in particular via the display 740. This can happen if, e.g., the identification 602 of the cartridge has been performed incorrectly or illegibly.

In a fourth step 604, the sample is processed by the processing unit after successful adaptation of the processing in the cartridge 500.

1. A method for adapting a processing of a biological sample using a processing unit, said method comprising:
identifying a cartridge, wherein the identification of the cartridge being performed in at least one identification region for a processing parameter;
reading of the processing parameter from the identified cartridge with the processing unit and adapting the processing depending on the processing parameter; and
processing of the sample in the cartridge by the processing unit.

2. The method according to claim 1, wherein the identification of the cartridge includes identifying a label that includes the at least one identification region for the processing parameter.

3. The method according to claim 1, wherein the processing is adapted with respect to a sample type of the sample.

4. The method according to claim 1, further comprising:
with a communication interface, prompting a user to enter the processing parameter if the reading of the processing parameter is unsuccessful.

5. A label for a microfluidic cartridge, comprising:
at least one identification region for a processing parameter used for adapting a processing of the cartridge.

6. The label according to claim 5, wherein at least one identification region includes identifiable information about the processing parameter.

7. The label according to claim 5, wherein the processing parameter includes information about at least one sample type.

8. The label according to claim 7, wherein the at least one identification region includes a first identification region for a first sample type and a second identification region for a second sample type.

9. The label according to claim 5, wherein the at least one identification region has an identification field that includes a code in which information about the processing parameter is encoded.

10. The label according to claim 5, wherein the at least one identification region includes at least one of (i) a sample identification region for a sample identifier and (ii) a cartridge identification region for a cartridge identifier of the cartridge.

11. A cartridge comprising:
at least one identification region including a processing parameter for adapting a processing of the cartridge.

12. The cartridge according to claim 11, further comprising:
a label having the at least one identification region.

13. The cartridge according to claim 11, further comprising:
a cartridge identifier applied to a surface of the cartridge.

14. A processing unit for processing a cartridge, wherein the processing unit is configured to adapt the processing with respect to a processing parameter read by the processing unit using the method according to claim 1.

15. A microfluidic system comprising:
the processing unit according to claim 14; and
the cartridge, which includes the at least one identification region including the processing parameter for adapting the processing of the cartridge.

16. The cartridge according to claim 13, wherein the cartridge is a microfluidic cartridge.

17. The cartridge according to claim 13, wherein the cartridge identifier is applied to the label.
